(19) United States
(12) Patent Application Publication
(10) Pub. No.: US 2008/0117192 A1
(43) Pub. Date: May 22, 2008

(54) Cancellation method and its circuit of line-decimated phenpmenon

(75) Inventors: Kuan-Hung Liu, Padeh City (TW); Shih-Hung Huang, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/907,488

(22) Filed: Oct. 12, 2007

(30) Foreign Application Priority Data
Nov. 17, 2006 (TW) 95142671

(51) Int. Cl. G09G 5/00; H04N 11/02

(52) U.S. Cl. 345/204; 375/240.01; 375/E07.076

(57) ABSTRACT

A cancellation method of line-decimated phenomenon and its circuit for a display device includes: inputting the video signal to a circuit of cancelling a line-decimated phenomenon; catching the unwanted data lines, which should be deleted; turning off the pulse of the signal CLKV to avoid the display device displaying the unwanted data.

### BACKGROUND OF THE INVENTION

1. Field of the Invention

The present invention generally relates to a cancellation method for cancelling an extraordinary display phenomenon and the used circuit thereof, more particularly, which are applied to cancel the line-decimated phenomenon for a flat panel display device.

2. Description of the Prior Art

The format of the analog data received from the driving circuit on the front side of the flat panel display (FPD) is for television system, and the receiving interface is usually an AV video connector (composite video connector) or an S-video connector. There are three data formats of the international standards for the television system currently, such as National Television Standards Committee (NTSC), Phase Alternating Line (PAL) and Sequential Color Avec Memory (SECAM) systems.

For the flat panel display on small-size and medium-size, its driving circuit on the front side supports both the NTSC and PAL systems. 30 frames (60 fields) are transferred per second in the NTSC system, and each frame is constructed by 525 data lines, namely each field is constructed by 262.5 data lines, wherein the odd data lines and the even data lines transfer the data by using interlacing. However, 25 frames (50 fields) are transferred per second in the PAL system, and each frame is constructed by 625 data lines. For instance, namely each field is constructed by 312.5 data lines, wherein the odd data lines and the even data lines transfer the data by using interlacing also.

Typically, a timing controller is set in the driving circuit at the front side of the flat panel display, and it transforms and reasonably distributes the video data which is decoded by a decoding circuit, to the display panel, that is it distributes the data from one time axis (analog data) to another time axis (panel display). Referring to FIG. 1, it illustrates a timing controller distributing analog data to a panel with 480*234 resolution. When the television system is an NTSC system, each field is constructed by 262.5 data lines. The timing controller selects 240 items of the valid data lines from odd frames and even frames respectively, and then the selected data lines send the data to the panel. According to the rule disconnecting 3 bottom lines and 3 top lines, it displays 234 lines on vertical resolution in frequency 60 Hz precisely. Therefore, it simulates the fields as the frames for the analog panel displaying. By the way, the application is not suitable for high revolution display devices, for example, the information technology (IT) monitor.

In addition, when the television is the PAL system, its controller uses another distributing method which is different from the NTSC system normally. For the system compatibility and reducing the amount of gates used in computing algorithm, the fast solution to enable both NTSC and PAL systems is to eliminate 100 data lines from the PAL system. It also means to eliminate 50 data lines in the field as the time interval between two data lines for the NTSC system is 63.49 μs and for the PAL system is 64 μs similarly. Thus, when the television system is switched from NTSC to the PAL, the video data lines are decimated necessary, and the displaying frequency decreases to 50 Hz.

FIG. 2A is a timing chart of the NTSC displaying mode in conventional way, and FIG. 2B is a timing chart of controlling signals switched from the NTSC displaying mode in FIG. 2A to the PAL displaying mode in conventional way. When the data line H9 is decimated from the system, its control signal STH (Source IC Start Pulse) should be eliminated, and the signal OEH (Output Enable Input For Data Driver) of the data line H8 should be delayed. The open signal CLKV (Gate IC Clock) of the Gate IC from the data line H8 should be eliminated. Therefore, the data line H9 will not be caught to display on the panel, and the data line H8 is delayed to display, that is to say, the data line H9 is decimated.

FIG. 3 illustrates a structure of the source IC in the driving circuit for decimating a data line in a conventional way. It includes a shift register 03, an analog sampling, a hold circuit 02, and an output buffer 01. FIG. 4A and FIG. 4B show the equivalent circuit of the structure according to FIG. 3 to illustrate the charge/discharge operation in a conventional way. The signal CPH (Sampling And Shifting Clock Pulse For Data Driver) controls the exclusive switches SW1 and SW2 of the analog sampling circuit. When the SW1 is conducted, the Source IC samples the data line n, and the data line n begins to charge the internal capacitor C1 to a potential which depends on the relation between the signal DATA and the signal AVSS (Ground For Analog Circuit). At the same time, the voltage of the data line n−1 on the capacitor C2 is inputted into a unity-gain operational amplifier 102, and then charges the pixel electrode 100. And when the signal OE (Gate IC Output Enable) drives an external switch to conduct the switch SW2, the analog Source IC samples the voltage of the data line n+1, and the voltage of the data line n+1 begins to charge the capacitor C2. At the same time, the voltage of the data line n on the capacitor C1 is inputted into the unity-gain operational amplifier 102, and then charges the pixel electrode 100 to output the data line n.

Accordingly, FIG. 5A and FIG. 5B are the operation of decimating lines in a conventional way. When the control signal CPH conducts the switch SW22, the voltage of the data line H7 is sampled. Meanwhile, the voltage of the data line H6 on the capacitor C11 is inputted into a unity-gain operational amplifier 202, and then charges the pixel electrode 200 to output the data line H6. And when the external signal OE drives the external switch to conduct the switch SW21 in the analog source IC, the voltage of the data line H8 is sampled. Meanwhile, the voltage of the data line H8 begins to charge the capacitor C11, at the same time, the voltage of the data line H7 on the capacitor C21 is inputted into the unity-gain operational amplifier 202, and then charges the pixel electrode 200 to output the data line H7. Next, for decimating the data line H9, the signal OE is held to stop switching on the external switch. Understandable, the exclusive switch SW21 keeps on the conducted state to continuously sample the voltage of the data line H8, and charges the capacitor C21. At the same time, the voltage of the data line H7 on the capacitor C21 continuously charges the pixel electrode 200 in order to keep outputting the data line H7 until the data line H9, which should be decimated, passes through, and then the signal OE returns to the normal action. Accordingly, the line-decimated algorithm is to delay the displaying of the data line H8 which is the forward data next to the decimated data until the decimated data passes through. During the data line H8 is delayed to display, the signal AVSS will affect the voltage of the data line H8 in sampling. Because the voltage holding time of the data line H8 is longer than other that of data lines, the signal AVSS affects the holding voltage of the data line H8 more obviously. And the abnormal phenomena on the decimated data line is clear from the other data lines. As the result, the display device displays abnormally as shown in FIG. 6.

### SUMMARY OF THE INVENTION

In order to solve the aforementioned problems, one object of the present invention is to provide a cancellation method of line-decimated phenomenon for a display device and the circuit employed thereof. It utilizes the control wave which is generated from an analog driving circuit for different video display devices. Therefore, it can eliminate data lines properly to transform the format of the image data from one video system to another video system.

Another object of the present invention is to provide a driving circuit to eliminate the pulses of signal CLKV corresponding to the given data lines of a display device. Thus the unwanted data lines will be caught like others, and won't be displayed on the panel, in other words, the data line is eliminated.

Another object of the present invention is to decimate the unwanted images which will not be stored in the circuit of the Source driver IC, and to keep the charging time of each video data line the same. For the display device, the linear reversible driving mode can effectively reduce the interruption from the signal AVSS (Ground For Analog Circuit) and avoid the abnormal line-decimated phenomenon.

For achieving the objects mentioned above, a cancellation method of line-decimated phenomenon for a display device according to the present invention includes: inputting a plurality of video data lines to a driving circuit; determining the first video data line from the driving circuit; eliminating a pulse of a clock signal (CLKV) corresponding to the first video data line so as to cancel the displaying of the first video data line, wherein the pulse of the clock signal (CLKV) controls the gate of a transistor for the first video data line; making the changing of an output enable input for scan driver signal (OEV) so as to keep a charging time of each video data line the same; changing a common electrode driving signal (VCOM) and a data signal (DATA) so as to keep a display device in a linear reversible driving mode ; and continually determining a second video data line from those video data lines for deletion and repeating the step of eliminating the pulse of the clock signal (CLKV).

For achieving the objects mentioned above, a cancellation driving circuit of line-decimated phenomenon for a display device according to the present invention includes: a video decoder used to receive a video signal and to decode the video signal; a timing controller used to generate a source control signal and a data control signal; a parameter selector used to provide a plurality of decoding parameters to the video decoder; a phase locked loop circuit used to provide a necessary frequency of the system to the timing controller; and a direct current to direct current (DC/DC) converter used to provide a working power to the circuit of cancelling the line-decimated phenomenon.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The foregoing aspects and many of the accompanying advantages of this invention will become more readily appreciated as the same becomes better understood by reference to the following detailed description, when taken in conjunction with the accompanying drawings, wherein:

FIG. 1 illustrates a timing controller distributing analog signal data to a panel with 480*234 resolution in a conventional way;

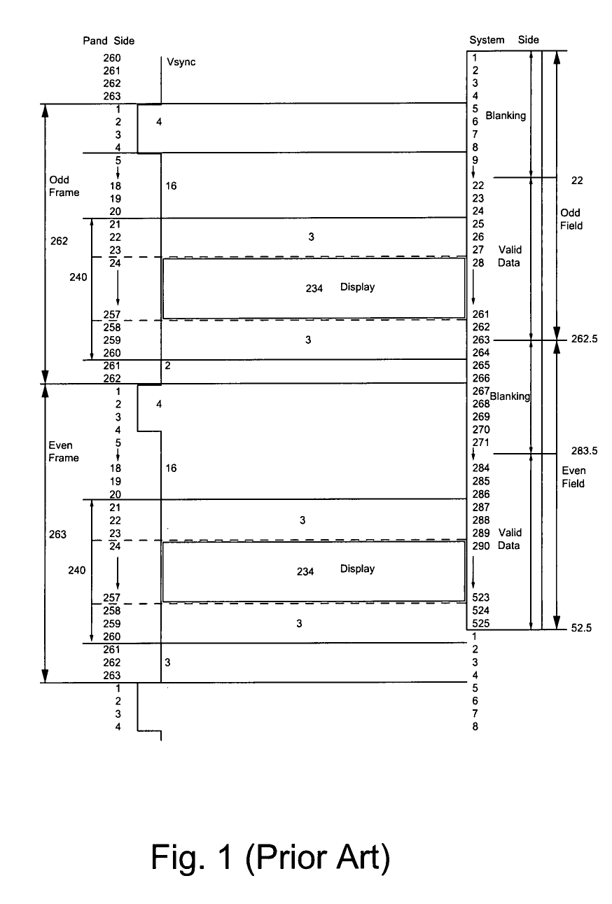

FIG. 2A is a timing chart of the NTSC displaying mode in conventional way;

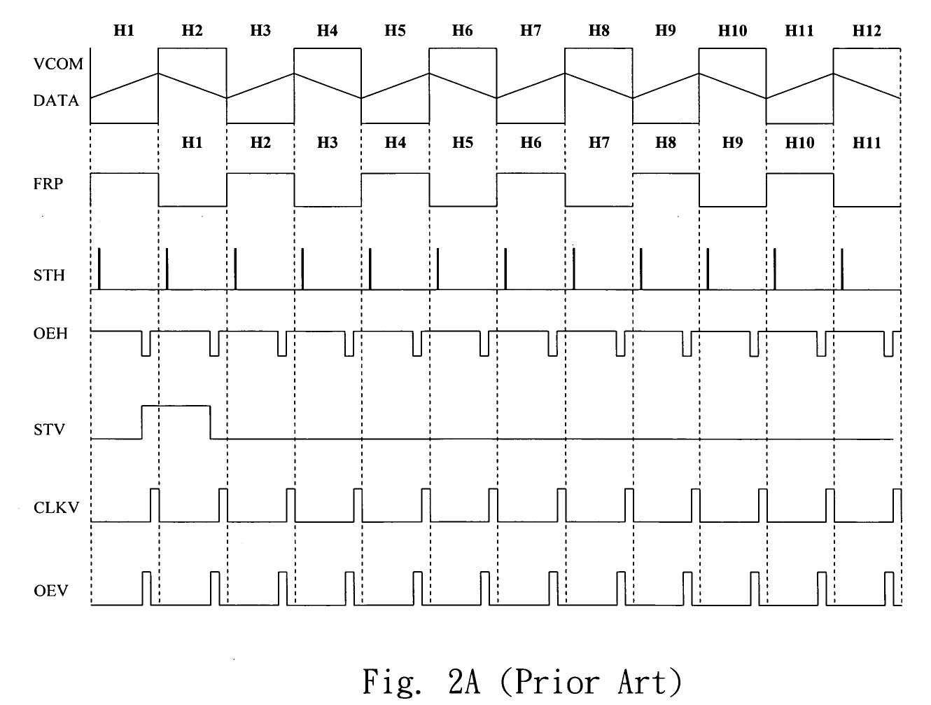

FIG. 2B is a timing chart of controlling signals switched from the PAL displaying mode in FIG. 2A to the NTSC displaying mode in conventional way;

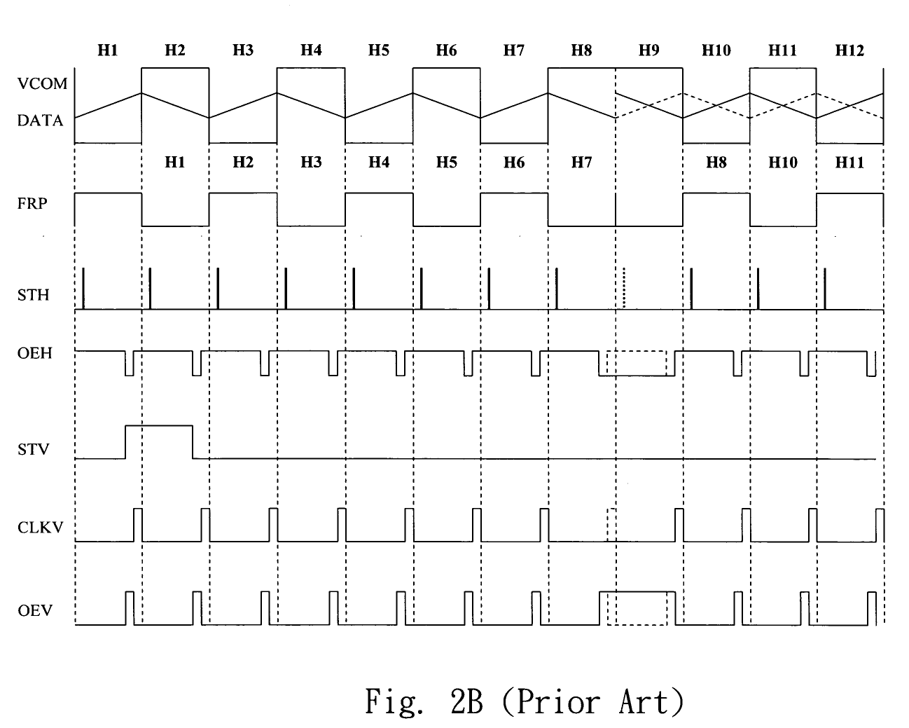

FIG. 3 illustrates the structure of the source IC in the driving circuit for decimation line in a conventional way;

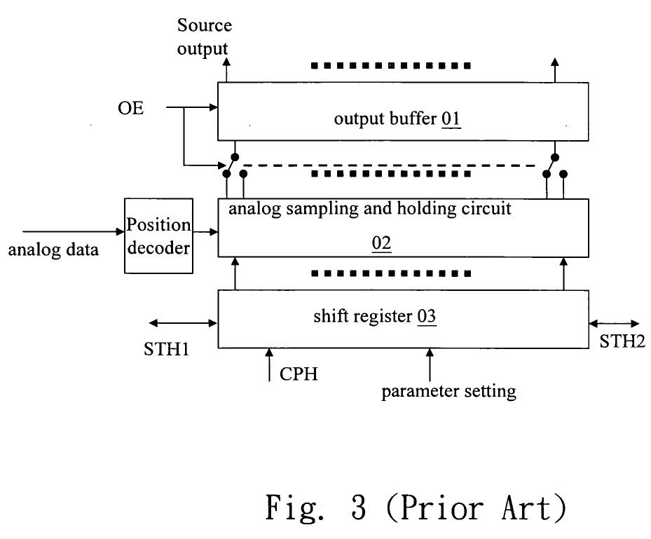

FIG. 4A and FIG. 4B are the output equivalent circuit according to FIG. 3, and illustrates the charge/discharge operation in a conventional way;

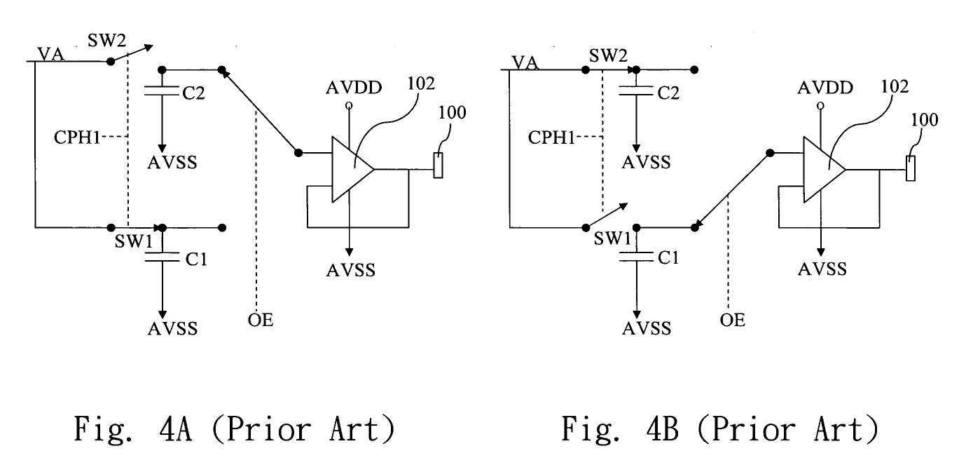

FIG. 5A and FIG. 5B are the operation of decimation line in a conventional way;

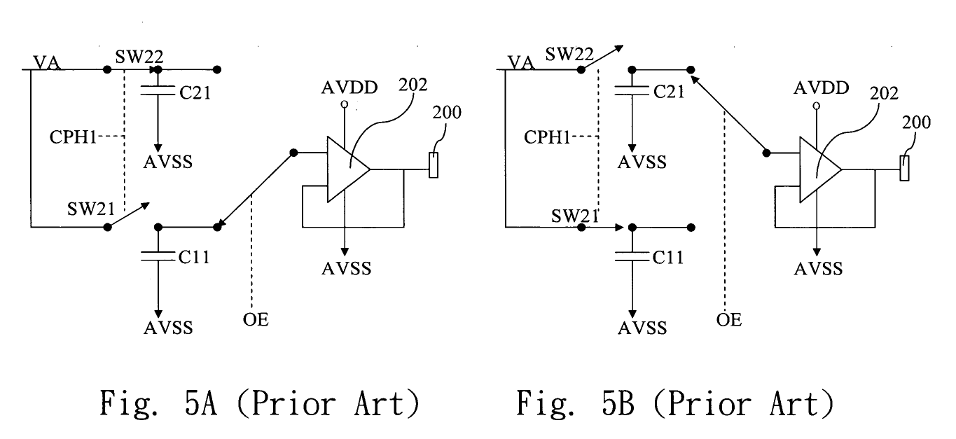

FIG. 6 is a picture of abnormal displaying;

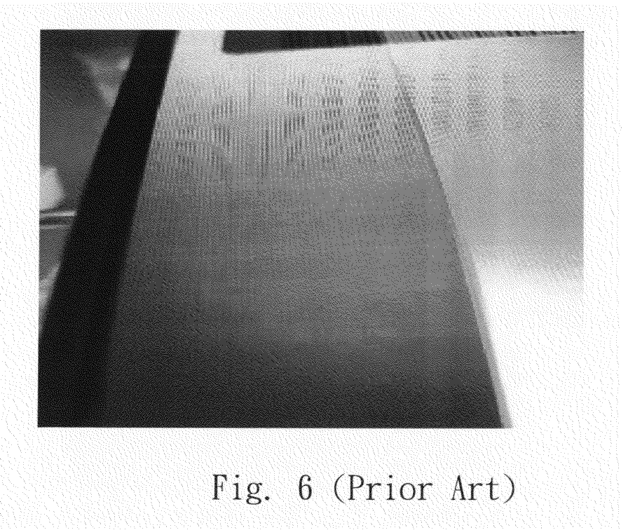

FIG. 7 illustrates a cancellation method of line-decimated for a display device according to one embodiment of the present invention;

FIG. 8 illustrates the system structure of the cancellation driving circuit according to one embodiment of the present invention; and

FIG. 9 illustrates the driving waves according to one embodiment of the present invention.

### DESCRIPTION OF THE PREFERRED EMBODIMENT

Reference will now be made in detail to the preferred embodiments of the present invention, examples of which are illustrated in the accompanying drawings.

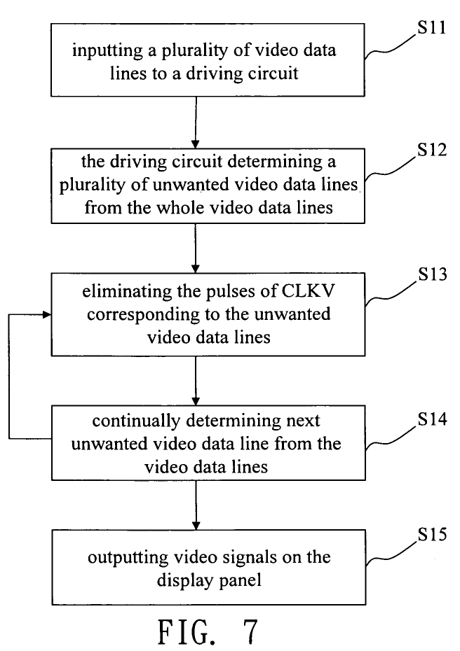

FIG. 7 illustrates a cancellation method of line-decimated phenomenon for the display device according to one embodiment of the present invention. The method includes: inputting a plurality of video signals, which are received from a PAL system by an analog circuit of a display device, to a driving circuit via a plurality of video data lines (step S11); determining unwanted video data lines from driving circuit, because the PAL system has more data lines than the NTSC system, the video signal of the unwanted video data lines should be pointed out(step S12); eliminating the pulses of the signal CLKV, corresponding to the unwanted video data line, to avoid the display device displaying the video signals of the unwanted video data lines, wherein the pulses of the clock signal CLKV control the gate of the transistor for video data lines (step S13); continually determining next unwanted video data line from all video data lines, and then repeating the step S13 until all unwanted video data lines are processed (step S14); and outputting video signals on the display panel, wherein the display panel is a flat panel display (step S15).

Accordingly, at the time of eliminating the pulses of signal CLKV to avoid the display device displaying the video signals of the unwanted data lines, the signal OEV (Output Enable Input For Scan Driver) is keeping changing so as to keep the charging time of each video data line the same. As the result, the signal VCOM (Common Electrode Driving Signal) and the signal DATA are changed to keep the linear reversible driving mode for the display device.

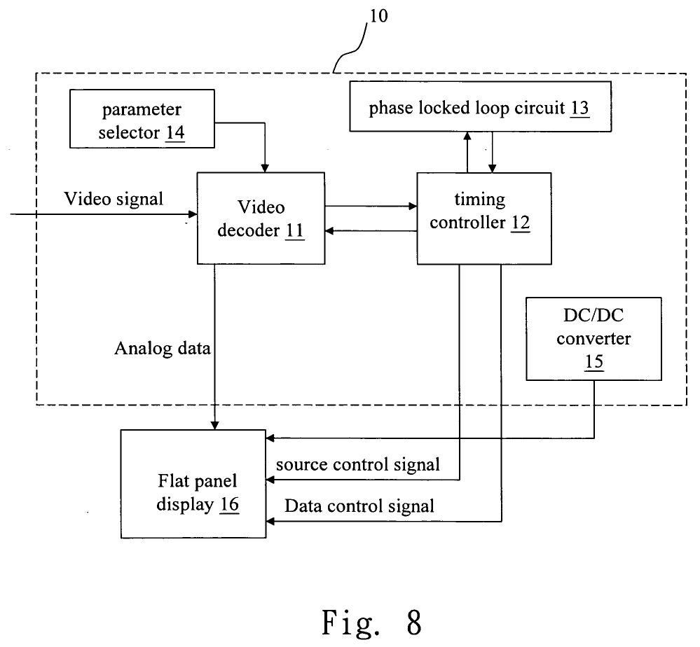

Additionally, for solving the wrong line-decimated phenomenon, when the input terminal of the flat panel display receives video signals from the PAL system, an embodiment of the present invention controls the wave shape of the pulse to cancel that phenomenon. The system structure of the cancellation driving circuit according to the embodiment of the present invention is an analog driving circuit 10 as illustrated in FIG. 8. The cancellation driving circuit of cancelling the line-decimated phenomenon includes: a video decoder 11 used to receive a standard video signal and to decode the video signal; a timing controller 12 generating a source control signal and a data control signal for source IC and gate IC of the flat panel display 16; a parameter selector 14 providing a plurality of decoding parameters to the video decoder 11 for different kinds of television system; a phase locked loop circuit 13 providing a frequency of the system for timing controller 12; and a direct current to direct current (DC/DC) converter 15 providing the operation power to the cancellation driving circuit 10 and the flat panel display 16, wherein the flat panel display 16 may be a light emitting diode (LED) display, a liquid crystal on silicon (LCoS) display, a liquid crystal display (LCD), a plasma display panel (PDP) or an organic light emitting diode (OLED) display.

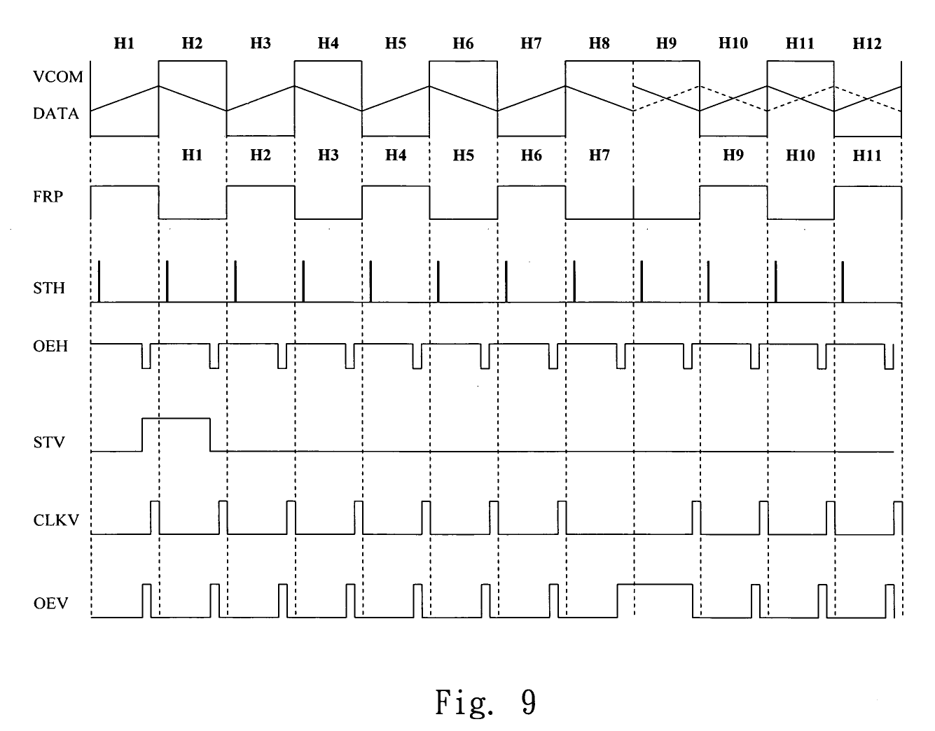

Furthermore, an embodiment of the present invention utilizes the timing controller to control the wave shape for compensating the timing after cancelling the decimated data line, and the wave shape are illustrated in FIG. 9. When the data H8 is decimated, the circuit eliminates the pulses of the signal CLKV corresponding to the unwanted video data lines. As this result, the data line H8 will be caught like others, but won't be displayed on the panel, in other word, the data line is eliminated. The changes of the signal OEV are used to keep the charging time of each video data line the same. The changes of the signal VCOM and the signal DATA are used to keep the linear reversible driving mode for the display device.

Accordingly, the present invention catches the unwanted data lines and does not display the unwanted data lines during the system switching from the NTSC system to the PAL system, so it does not hold any data line in the source IC for a time interval between two data lines to eliminate it. This method effectively reduces the interruption from the signal AVSS and avoids the abnormal line-decimated phenomenon.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A cancellation method of line-decimated phenomenon, comprising:
inputting a plurality of video data lines to a driving circuit;
determining a first video data line from said driving circuit;
eliminating a pulse of a clock signal corresponding to said first video data line so as to cancel a displaying of said first video data line, wherein said pulse of said clock signal controls a gate of a transistor for said first video data line;
changing an output enable input for scan driver signal so as to keep a charging time of each said video data line the same;
changing a common electrode driving signal and a data signal so as to keep a display device in a linear reversible driving mode; and
continually determining a second video data line from said plurality of video data lines for deletion.

2. A cancellation method of line-decimated phenomenon according to claim 1, wherein said video data lines are scanning lines of phase alternating line system.

3. A cancellation method of line-decimated phenomenon according to claim 1, wherein the step of said eliminating said pulse of said clock signal utilizes means of controlling the wave shape of said pulse to inactive said gate of said transistor to display said decimation line on said display device.

4. A cancellation method of line-decimated phenomenon according to claim 1, further comprising outputting a video signal in a system format on said display device.

5. A cancellation method of line-decimated phenomenon according to claim 4, wherein said system format is a national television standards committee system.

6. A method of cancelling line-decimated phenomenon according to claim 1, wherein said display device is a flat panel display.

7. A cancellation method of line-decimated phenomenon according to claim 6, wherein said flat panel display is a light emitting diode display, a liquid crystal on silicon display, a liquid crystal display, a plasma display panel or an organic light emitting diode display.

8. A cancellation driving circuit of line-decimated phenomenon, applied to a display device, comprising:
a video decoder, used to receive a video signal and to decode said video signal;
a timing controller, used to generate a source control signal and a data control signal;
a parameter selector, used to provide a plurality of decoding parameters to said video decoder;
a phase locked loop circuit, used to provide a frequency of the system to said timing controller; and
a direct current to direct current converter, used to provide a working power to said cancellation driving circuit.

9. A cancellation driving circuit of line-decimated phenomenon according to claim 8, wherein said display device is a flat panel display.

10. A cancellation driving circuit of line-decimated phenomenon according to claim 9, wherein said flat panel display is a light emitting diode display, a liquid crystal on silicon display, a liquid crystal display, a plasma display panel or an organic light emitting diode display.

11. A cancellation driving circuit of line-decimated phenomenon according to claim 8, wherein said direct current to direct current converter furthermore provides said display device an operation power.
